(19) United States
(12) Patent Application Publication
(10) Pub. No.: US 2002/0091618 A1
(43) Pub. Date: Jul. 11, 2002

(54) On-line sale client web site managing system

(76) Inventor: Chen Shi Yang, San Jose, CA (US)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/810,197

(22) Filed: Mar. 19, 2001

(30) Foreign Application Priority Data
Jan. 5, 2001 (TW) 090100413

(51) Int. Cl. G06F 17/60

(52) U.S. Cl. 705/37; 705/39

(57) ABSTRACT

On-line sale client web site managing system. An enterprise web site is built in a servo main frame, enabling an enterprise owner to through internet make on-line sale trade with clients. The enterprise web site includes a client web site managing system by which clients can directly set up basic data of their companies or personal basic data in the enterprise web site. The client web site managing system includes a client data managing system, a client department managing system, a client employee managing system and a price query/negotiation record managing system. The present invention provides a trade web site which can easily combine information of the enterprise and clients and make on-line sale.

### BACKGROUND OF THE INVENTION

The present invention is related to an on-line sale client web site managing system, and more particularly to a trade web site managing system which through internet makes on-line sale. By means of this web site managing system, the information of clients are combined with the sale system of an enterprise owner.

It is a trend to trade by way of electronic business. However, the current trade mode is at most such that the products of an enterprise are shown in a web site of the enterprise to lower the cost for a shop and agents. Moreover, there is only business-to-customer trade, while there is no business-to-business trade. Also, the trade management of the enterprise still necessitates cooperation between salesmen, product managing personnel, production unit, purchasers and accountants. It is quite expensive for a small or middle-size company to set up and maintain an electronic business web site.

### SUMMARY OF THE INVENTION

It is therefore a primary object of the present invention to provide an on-line sale client web site managing system which enables an enterprise owner to easily manage company and personal data of clients so as to save the cost and labor for setting up and maintaining electronic business web site.

It is a further object of the present invention to provide the above on-line sale client web site managing system which is able to promote sale management efficiency, expedite sale of products and create more profit for the enterprise.

It is still a further object of the present invention to provide the above on-line sale client web site managing system which by way of web site combines internal resource of the enterprise with the resource of downstream clients to achieve the object of management of purchase, sale and storage.

The present invention can be best understood through the following description and accompanying drawings wherein:

### BRIEF DESCRIPTION OF THE DRAWINGS

FIG. 1 is a diagram showing the structure of the on-line sale trade web site of the present invention;

FIG. 2 is a diagram showing the structure of the client web site managing system of the present invention;

FIG. 3 is a flow chart of the client data managing system of the present invention;

FIG. 4 is a flow chart of the client department managing system of the present invention;

FIG. 5 is a flow chart of the client employee managing system of the present invention; and

FIG. 6 is a flow chart of the price query/negotiation record managing system of the present invention.

### DETAILED DESCRIPTION OF THE PREFERRED EMBODIMENT

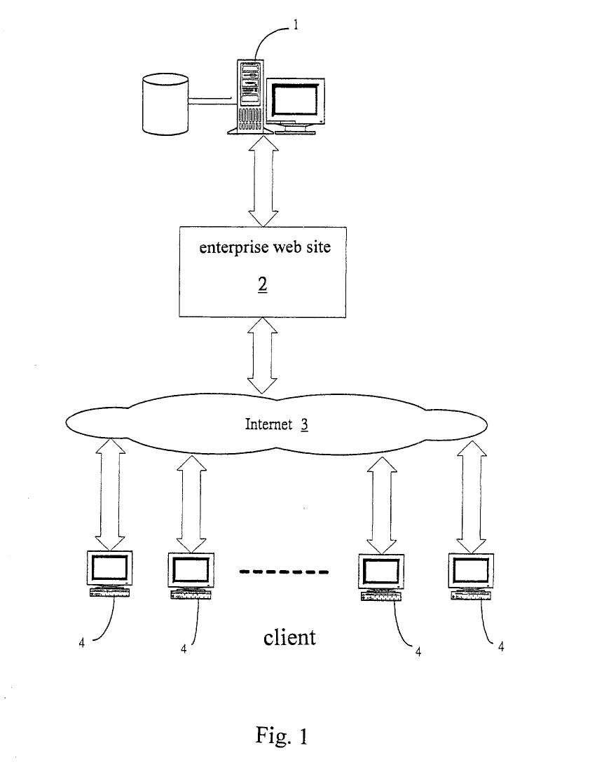

Please refer to FIG. 1. Through internet, the present invention establishes a trade web site for making on-line purchase trade. According to the present invention, an enterprise web site 2 is built in an inside servo main frame 1 of the enterprise. The enterprise web site 2 enables an enterprise owner to through internet 3 make sale trade with one or more than one client 4. Each client 4 also can through a computer connect with the internet 3 and gain access to the enterprise web site 2 to make business trade with the enterprise owner. The applicant's Taiwanese Patent Application No. 89127191, filed on Dec. 19, 2000, discloses a trading method and system using a computer to make on-line sale. The web page formality used by the enterprise web site of the present invention is written in HTML, JAVA SCRIPT, SQL, JSP, etc., including distributive construction, article guide technique, interactively used interface, etc. The hardware used in the present invention for connecting with the internet include computer, modem, xDSL modem, cable modem, modem private line, etc. The software include web page viewer, mail transceiver, etc.

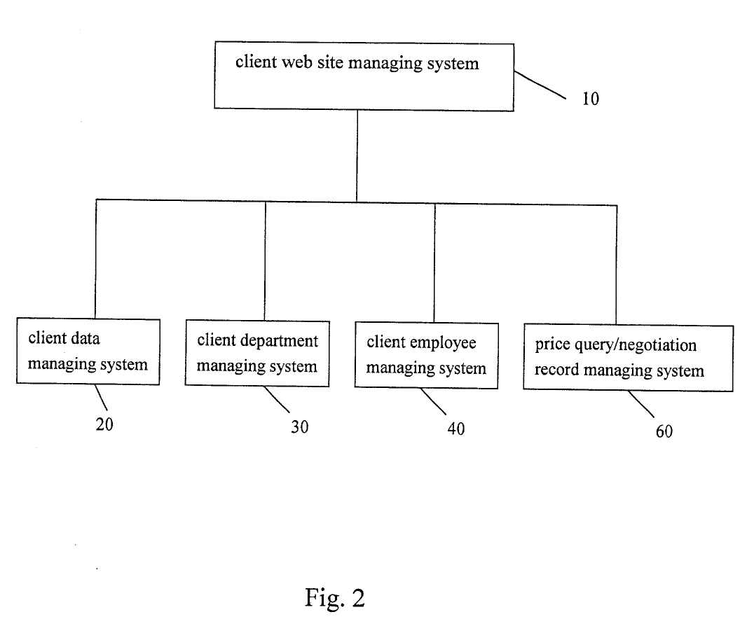

FIG. 2 shows the main structure of the client web site managing system for making on-line sale of the present invention. An enterprise web site 2 is built in an inside servo main frame 1 of the enterprise. The enterprise web site 2 mainly includes a client web site managing system 10 by which clients set up basic data of their companies or personal basic data on the enterprise web site 2. Accordingly, clients can make on-line purchase and query and negotiation of price.

After the clients set up and maintain their basic data, the enterprise owner can use these data to go for sale trade without re-inputting data. Each time the clients gain access to the enterprise web site 2, they must first input client codes, user codes and passwords. Only after identified, the clients can enter the enterprise web site 2 for trade. The client web site managing system 10 includes a client data managing system 20, a client department managing system 30, a client employee managing system 40 and a price query/negotiation record managing system 60. The client data managing system 20 mainly serves to set up and maintain basic data of clients' companies or personal basic data of the clients. The client department managing system 30 mainly serves to set up and maintain the department data of company clients. The client employee managing system 40 mainly serves to set up and maintain the employee data of company clients. The price query/negotiation record managing system 60 mainly serves to maintain and manage the price query/negotiation lists of the clients to the enterprise owner.

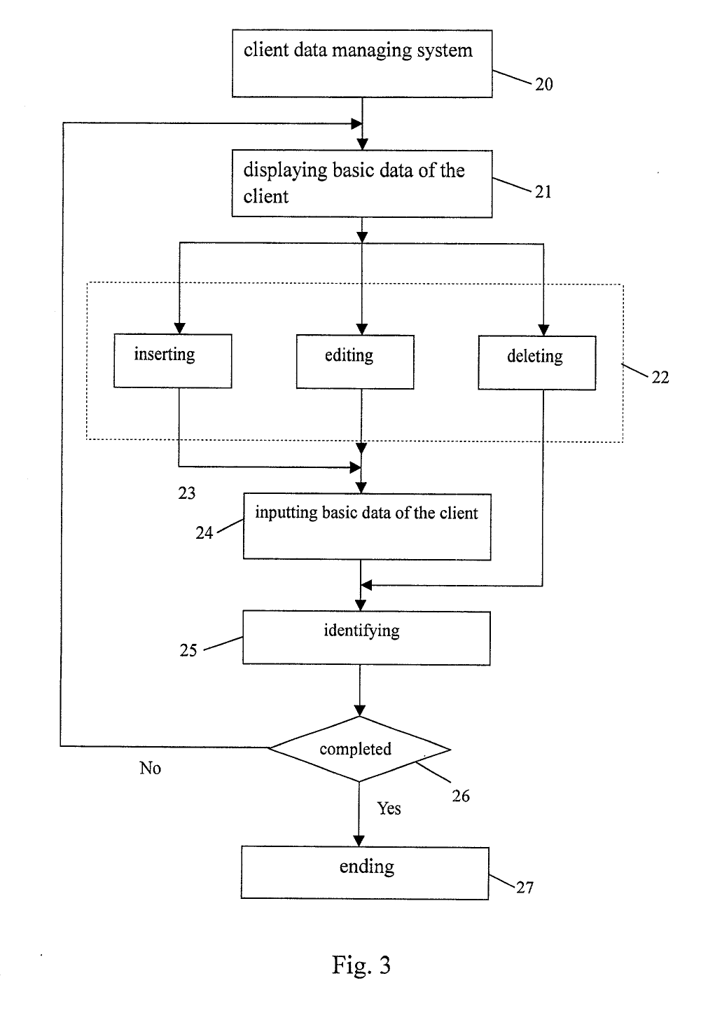

FIG. 3 is a managing flow chart of client data according to the present invention. The client data managing system 20 of the present invention enables the clients gaining access to the enterprise web site 2 to insert, edit and delete company basic data or personal basic data in preset field. The set up or maintained data are all stored a database of the servo main frame 1. The execution steps of the client data managing system 20 include:

(a) displaying basic data of the client in the database 21;

(b) inserting, editing or deleting basic data of the client 22, in case of editing, jumping to step (d), in case of deletion of field, jumping to step (e);

(c) inserting client data, the present invention automatically giving a client code 23;

(d) inputting basic data of the client 24;

(e) identifying 25, after identified, the basic data of the client being stored in the database;

(f) if insertion, edition or deletion is completed 26, if not, steps (a) to (f) being repeated; and

(g) insertion, edition or deletion of basic data of the client is completed 27.

In the case that the client is a company, the client data managing system 20 includes preset fields for the client's basic data include:

a company name field including field of Chinese and English names and abbreviations or short names, etc.;

a company address field including field of country, state/province, city, zip code and detailed address, etc.;

a telephone/facsimile field including field of telephone number, cellular phone number and facsimile number, etc.;

a company web address field;

a company data field including field of capital, number of employees, classification of business, etc.;

a president field including field of name, extension number, E-mail box, etc. of the president;

a company contact man field including field of name, position, extension number, E-mail box, etc. of the contact man;

an invoice data field including field of invoice classification, invoice title, invoice address, etc.;

a shipping manner field including field of shipping condition, shipping description and delivery date, etc.;

a trade manner field including field of trade manner, trade condition description, trade monetary kind, pay way, pay condition description, pay date, tax rate, etc.;

a registration date field;

a use period field including on-line date and off-line date; and

a bank data field including field of bank name, account classification, account name, account number, bank address, telephone and facsimile numbers of bank contact man, etc.

In the case that the client is a customer, the client data managing system 20 includes preset fields for the client's basic data:

a customer name field including field of Chinese and English names, etc.;

a customer contact field including field of telephone number, facsimile number, E-mail box, etc.;

an invoice data field including field of invoice classification, invoice title, invoice address, etc.;

a shipping manner field including field of shipping condition, shipping description and delivery date, etc.;

a trade manner field including field of trade manner, trade condition description, trade monetary kind, pay way, pay condition description, pay date, tax rate, etc.;

a registration date field;

a use period field including on-line date and off-line date; and

a credit card data field including field of credit card classification, credit card number, issuing bank, credit card effective period, etc.

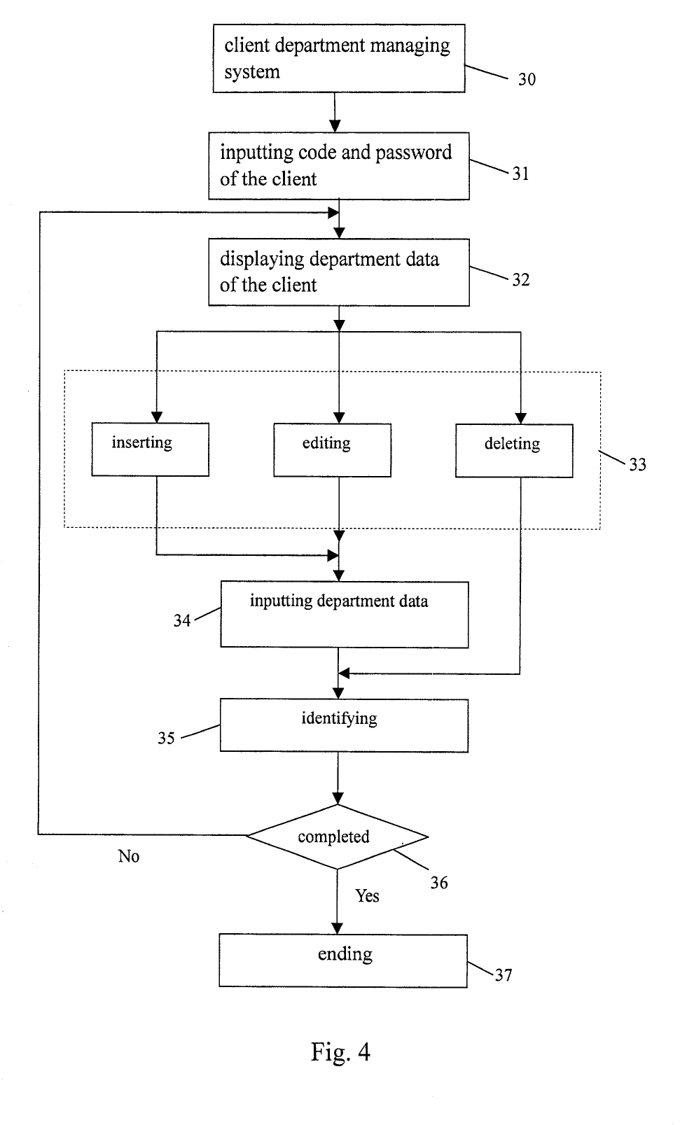

FIG. 4 is a flow chart of management of client department according to the present invention. With respect to company clients, the client department managing system 30 of the present invention enables the clients to use the enterprise web site 2 to manage the department data of their own companies. The clients can manage these departments according to different products (such as official machine department or computer sale department) or different business properties (such as business department or accounting department). The execution steps of the client department managing system 30 include:

(a) inputting code and password of the client 31;

(b) displaying department data of the client in the database 32;

(c) inserting, editing or deleting a department 33, in case of deletion, jumping to step (e), otherwise, next step being executed;

(d) inputting department data 34, including field of department name, department code, department description, etc.;

(e) identifying 35, after identified, the department data being stored in the database;

(f) if insertion, edition or deletion of department data is completed 36, if not, steps (b) to (f) being repeated; and

(g) insertion, edition or deletion of department data of the client is completed 37.

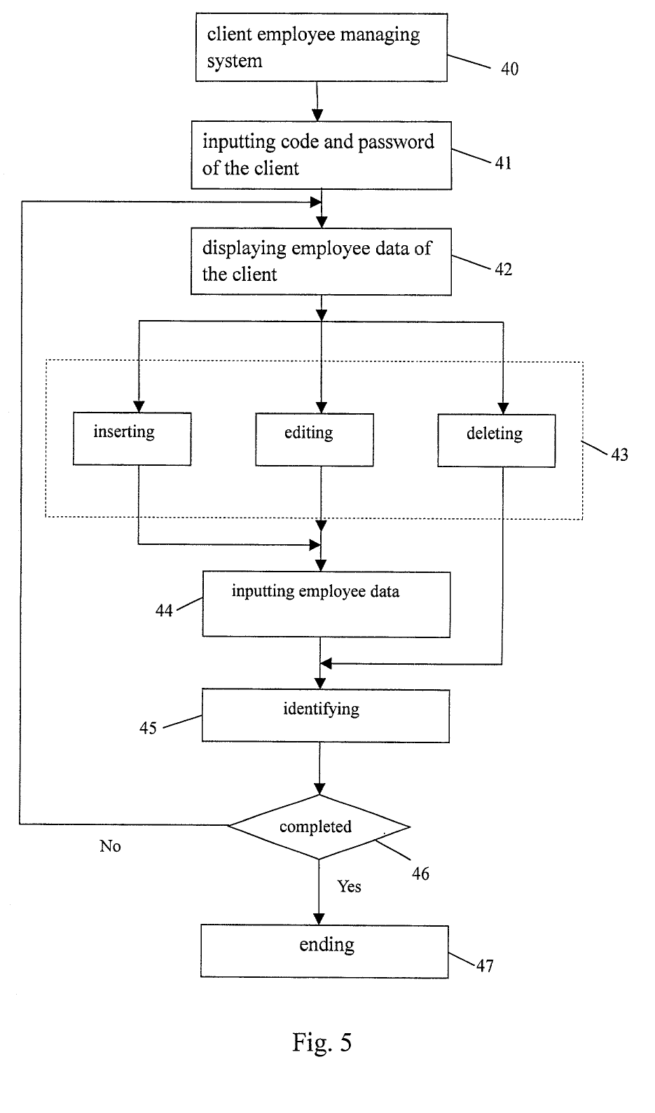

FIG. 5 is a flow chart of management of client employees according to the present invention. With respect to company clients, the client employee managing system 40 of the present invention enables the clients to manage data of those employees who can gain access to the enterprise web site 2 for trade. The execution steps of the client employee managing system 40 include:

(a) inputting code and password of the client 41;

(b) displaying employee data of the client in the database 42;

(c) inserting, editing or deleting employee data 43, in case of deletion, jumping to step (e), otherwise, next step being executed;

(d) inputting employee data 44, including name, department classification, on-line period, contact data, etc.;

(e) identifying 45, after identified, the employee data being stored in the database;

(f) if insertion, edition or deletion of employee data is completed 46, if not, steps (b) to (f) being repeated; and

(g) insertion, edition or deletion of data of employees of the client is completed 47.

The client employee data managing system 40 of the present invention includes preset fields for the employee data:

a department classification field;

a registration name field;

a registration password field including field of double check, password reminder, answer, etc.;

a registration period field including on-line date and off-line date;

an employee data field including field of Chinese and English names, identification number, employee serial number, etc.;

a contact telephone field including field of telephone number, extension number, facsimile number, cellular phone number, etc.; and

an employee basic data field including field of identification number, residence address, education degree, past career, interest, hobby, etc.

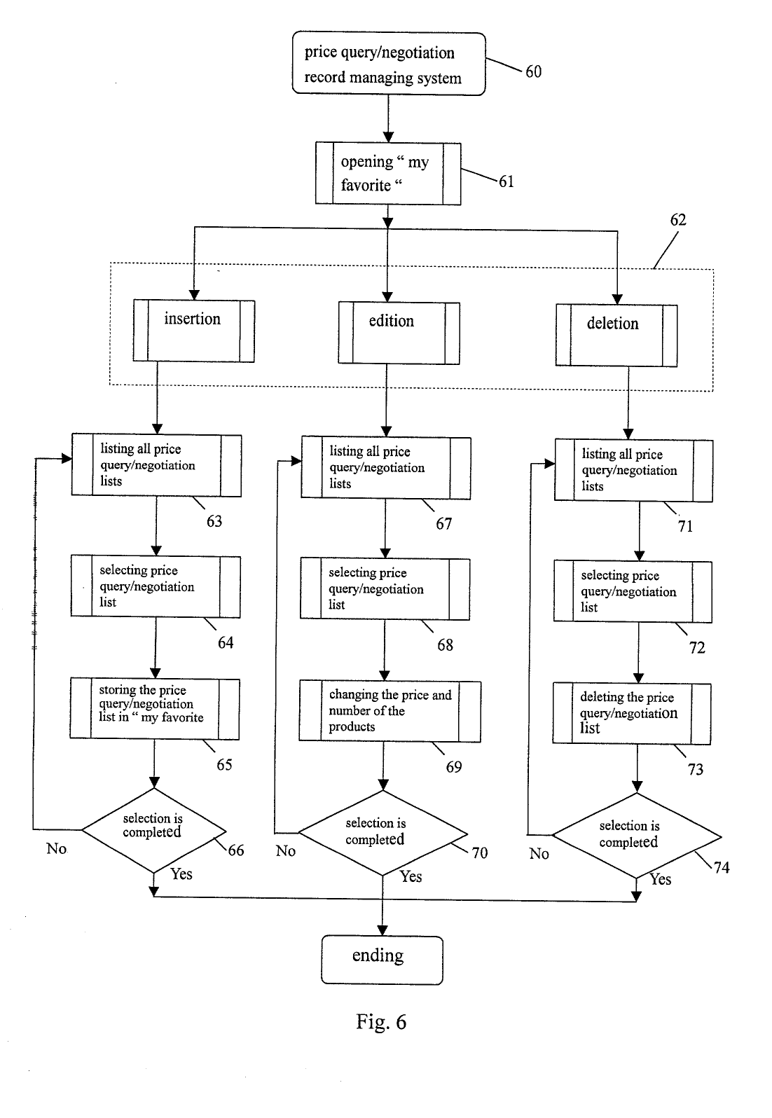

FIG. 6 is a structural block diagram of the price query/negotiation record managing system 60 of the present invention. The price query/negotiation record managing system 60 enables a client to manage the price query/negotiation list records between the client and the enterprise owner. There may be numerous data in the price query/negotiation list records due to a plurality of clients and times of trade. It will cost the client very much time in case each time the client gains access to the enterprise web site 2 for trade, the client must search the past or current price query/negotiation list records. The present invention enables the client to store the price query/negotiation list in proceeding or store the price query/negotiation list of certain specific trade (such as urgent case ). Accordingly, the client can according to the record make further trade or re-negotiate the price. The present invention permits all clients to use personal “my favorite” to manage the price query/negotiation list records. The execution steps of the price query/negotiation record managing system 60 include:

(a) opening “my favorite” 61;

(b) selecting insertion, edition or deletion of the price query/negotiation list records in the “my favorite” 62, in case of insertion, step (c) being executed, in case of edition, step (g) being executed, in case of deletion, step (k) being executed;

(c) listing all price query/negotiation lists in the database 63;

(d) selecting price query/negotiation list needing to insert 64;

(e) storing the price query/negotiation list in “my favorite” 65;

(f) if selection is completed 66, if not, steps (c) to (f) being repeated, if so, “my favorite” being stored into the database of the servo main frame 1 to complete the insertion;

(g) listing all price query/negotiation lists in “my favorite” 67;

(h) selecting price query/negotiation list needing to edit 68;

(i) changing the price and number of the products listed in the price query/negotiation list 69;

(j) if selection is completed 70, if not, steps (g) to (j) being repeated, if so, “my favorite” being stored into the database of the servo main frame 1 to complete the edition;

(k) listing all price query/negotiation lists in “my favorite” 71;

(l) selecting price query/negotiation list needing to delete 72;

(m) deleting the price query/negotiation list 73; and

(n) if selection is completed 74, if not, steps (k) to (n) being repeated, if so, “my favorite” being stored into the database of the servo main frame 1 to complete the deletion.

The on-line sale client web site managing system of the present invention is characterized by:

1. The present invention enables an enterprise owner to easily manage data of clients so as to lower cost, save personnel fee and promote management efficiency.

2. The present invention can build private web site of the enterprise as necessary to have an advantageous position in electronic business and also simplify the procedure of sale.

3. The present invention by way of web site combines internal resource of the enterprise with the resource of downstream clients to achieve the object of management of purchase, sale and storage.

The above embodiment is only used to illustrate the present invention, not intended to limit the scope thereof. Many modifications of the above embodiment can be made without departing from the spirit of the present invention.

What is claimed is:

1. On-line sale client web site managing system, an enterprise web site being built in a servo main frame, the enterprise web site enabling an enterprise owner to through internet make sale trade with one or more than one client, the enterprise web site mainly including a client web site managing system by which clients set up basic data of their companies or personal basic data on the enterprise web site, by means of the set up data, the enterprise owner can make sale trade with the clients, the client web site managing system including:
a client data managing system mainly serving to set up and maintain basic data of the clients' companies or personal basic data of the clients;
a client department managing system mainly serving to set up and maintain the department data of company clients;
a client employee managing system mainly serving to set up and maintain the employee data of company clients; and
a price query/negotiation record managing system mainly serving to maintain and manage the price query/negotiation lists of the clients to the enterprise owner.

2. On-line sale client web site managing system as claimed in claim 1, wherein the client data managing system enables the clients gaining access to the enterprise web site to insert, edit and delete company basic data or personal basic data in preset field, the execution steps of the client data managing system including:
(a) displaying basic data of the client;
(b) inserting, editing or deleting basic data of the client, in case of editing, jumping to step (d), in case of deletion of field, jumping to step (e);
(c) automatically giving a client code;
(d) inputting basic data of the client;
(e) identifying;
(f) if insertion, edition or deletion is completed, if not, steps (a) to (f) being repeated; and
(g) insertion, edition or deletion of basic data of the client is completed.

3. On-line sale client web site managing system as claimed in claim 2, wherein in step (d), in the case that the client is a company, the client data managing system includes preset fields for the client's basic data include:
a company name field including field of Chinese and English names and abbreviations or short names, etc.;
a company address field including field of country, state/province, city, zip code and detailed address, etc.;
a telephone/facsimile field including field of telephone number, cellular phone number and facsimile number, etc.;
a company web address field;
a company data field including field of capital, number of employees, classification of business, etc.;
a president field including field of name, extension number, E-mail box, etc. of the president;
a company contact man field including field of name, position, extension number, E-mail box, etc. of the contact man;
an invoice data field including field of invoice classification, invoice title, invoice address, etc.;
a shipping manner field including field of shipping condition, shipping description and delivery date, etc.;
a trade manner field including field of trade manner, trade condition description, trade monetary kind, pay way, pay condition description, pay date, tax rate, etc.;
a registration date field;
a use period field including on-line date and off-line date; and
a bank data field including field of bank name, account classification, account name, account number, bank address, telephone and facsimile numbers of bank contact man, etc.

4. On-line sale client web site managing system as claimed in claim 2, wherein in step (d), in the case that the client is a customer, the client data managing system includes preset fields for the client's basic data include:
a customer name field including field of Chinese and English names, etc.;
a customer contact field including field of telephone number, facsimile number, E-mail box, etc.;
an invoice data field including field of invoice classification, invoice title, invoice address, etc.;
a shipping manner field including field of shipping condition, shipping description and delivery date, etc.;
a trade manner field including field of trade manner, trade condition description, trade monetary kind, pay way, pay condition description, pay date, tax rate, etc.;
a registration date field;
a use period field including on-line date and off-line date; and
a credit card data field including field of credit card classification, credit card number, issuing bank, credit card effective period, etc.

5. On-line sale client web site managing system as claimed in claim 1, wherein with respect to company clients, the client department managing system enables the clients to use the enterprise web site to manage the department data of their own companies, the execution steps of the client department managing system including:
(a) inputting code and password of the client;
(b) displaying department data of the client;
(c) inserting, editing or deleting a department, in case of deletion, jumping to step (e), otherwise, next step being executed;
(d) inputting department data;
(e) identifying;
(f) if insertion, edition or deletion of department data is completed, if not, steps (b) to (f) being repeated; and
(g) insertion, edition or deletion of department data of the client is completed.

6. On-line sale client web site managing system as claimed in claim 1, wherein with respect to company clients, the client employee managing system enables the clients to manage data of those employees who can gain access to the enterprise web site for trade, the execution steps of the client employee managing system including:
(a) inputting code and password of the client;
(b) displaying employee data of the client;
(c) inserting, editing or deleting employee data, in case of deletion, jumping to step (e), otherwise, next step being executed;
(d) inputting employee data;
(e) identifying;
(f) if insertion, edition or deletion of employee data is completed, if not, steps (b) to (f) being repeated; and
(g) insertion, edition or deletion of data of employees of the client is completed.

7. On-line sale client web site managing system as claimed in claim 5, wherein in step (d), the client employee data managing system includes preset fields for the employee data:
a department classification field;
a registration name field;
a registration password field including field of double check, password reminder, answer, etc.;
a registration period field including on-line date and off-line date;
an employee data field including field of Chinese and English names, identification number, employee serial number, etc.;
a contact telephone field including field of telephone number, extension number, facsimile number, cellular phone number, etc.; and
an employee basic data field including field of identification number, residence address, education degree, past career, interest, hobby, etc.

8. On-line sale client web site managing system as claimed in claim 1, wherein the price query/negotiation record managing system enables all clients to use personal “my favorite” to manage the price query/negotiation list records, the execution steps of the price query/negotiation record managing system including:
(a) opening “my favorite”;
(b) selecting insertion, edition or deletion of the price query/negotiation list records in the “my favorite”, in case of insertion, step (c) being executed, in case of edition, step (g) being executed, in case of deletion, step (k) being executed;
(c) listing all price query/negotiation lists;
(d) selecting price query/negotiation list needing to insert;
(e) storing the price query/negotiation list in “my favorite”;
(f) if selection is completed, if not, steps (c) to (f) being repeated, if so, “my favorite” being stored to complete the insertion;
(g) listing all price query/negotiation lists in “my favorite”;
(h) selecting price query/negotiation list needing to edit;
(i) changing the price and number of the products listed in the price query/negotiation list;
(j) if selection is completed, if not, steps (g) to (j) being repeated, if so, “my favorite” being stored to complete the edition;
(k) listing all price query/negotiation lists in “my favorite”;
(l) selecting price query/negotiation list needing to delete;
(m) deleting the price query/negotiation list; and
(n) if selection is completed, if not, steps (k) to (n) being repeated, if so, “my favorite” being stored to complete the deletion.
